(19) United States
(12) Patent Application Publication
(10) Pub. No.: US 2019/0303174 A1
(43) Pub. Date: Oct. 3, 2019

(54) REGISTER RECONFIGURATION USING DIRECT DESCRIPTOR FETCH FOR EFFICIENT MULTI-PASS PROCESSING OF COMPUTER VISION AND VIDEO ENCODING APPLICATIONS

(71) Applicant: QUALCOMM Incorporated, San Diego, CA (US)

(72) Inventors: Srikanth ALAPARTHI, San Diego, CA (US); Harikrishna REDDY, San Jose, CA (US); Yasutomo MATSUBA, San Diego, CA (US); Ashish MEDEWAR, San Diego, CA (US); Siddharth KHIMSARA, San Diego, CA (US)

(21) Appl. No.: 16/368,301

(22) Filed: Mar. 28, 2019

Related U.S. Application Data
(60) Provisional application No. 62/650,230, filed on Mar. 29, 2018.

(51) Int. Cl. G06F 9/445

(52) U.S. Cl. CPC G06F 9/44505

(57) ABSTRACT

Systems and methods implemented in firmware and hardware domains may include writing by the firmware domain configuration information to a memory for a plurality of passes of hardware processing, programming by the hardware domain configuration registers with the configuration information retrieved from the memory, and processing by the hardware domain the plurality of passes in accordance with the configuration information programmed in the configuration registers. The configuration registers may be programmed after the configuration information are written to the memory.

### CROSS-REFERENCE TO RELATED APPLICATION

The present application for patent claims the benefit of U.S. Provisional Application No. 62/650,230, entitled “REGISTER RECONFIGURATION USING DIRECT DESCRIPTOR FETCH FOR EFFICIENT MULTI-PASS PROCESSING OF COMPUTER VISION AND VIDEO ENCODING APPLICATIONS,” filed Mar. 29, 2018, assigned to the assignee hereof, and expressly incorporated herein by reference in its entirety.

### FIELD OF DISCLOSURE

Disclosed aspects are directed to improving configuration of registers in a firmware-hardware interface for expedited hardware processing, in example applications such as computer vision and video encoding.

### BACKGROUND

In conventional designs of hardware (HW)-firmware (FW) processing flow, HW configurable registers, e.g., software interface (SWI) registers, are derived and programmed in a sequence by FW, at fixed intervals. The fixed intervals may be, for example, on a per-frame basis for video processing. In these designs, a HW processor or core initiates an interrupt (IRQ) indicating the end of a current interval to the FW, upon detection of which, a FW processor (e.g., a video processor) can initiate the configuration of a new sequence in the SWI registers. The programming of these SWI registers involves some processing times, which includes the time taken by the FW processor to derive new values for the sequences, memory access latencies for reading related information from an external memory, and related cache misses. These processing times can become significant and limit HW processing time of the HW core. This problem is exacerbated at higher frame rates. The use of multi-processing architectures, or multi-threaded processing of each frame, e.g., for computer vision algorithms also adds pressure on the needs for reducing the processing times.

FIG. 1 illustrates processing system 100, showing a conventional HW-FW partition 105 between firmware (FW) 106 and hardware (HW) 110. In more detail. FIG. 1 shows an example processor 102 for video FW processing (e.g., an ARM processor) with cache 104 in the domain of FW 106, and software interface (SWI) registers 112 and hardware (HW) core 114 in the HW 110 domain. Processing system 100 may also include memory 120 (e.g., an external memory such as a double data rate (DDR) memory), with respective interfaces 116 and 118 to the above-described processor 102 and HW core 114. In processing system 100, the latencies involved in the programming of SWI registers 112 in the HW 110 domain through the processor 102 in the FW 106 domain may be significant. As previously noted, cache misses for cache 104 in retrieving information from memory 120 may further add to these undesirable delays.

Correspondingly, there is a need to mitigate the aforementioned delays associated with programming the registers and for improving the processing speeds.

### SUMMARY

This summary identifies features of some example aspects, and is not an exclusive or exhaustive description of the disclosed subject matter. Whether features or aspects are included in, or omitted from this summary is not intended as indicative of relative importance of such features. Additional features and aspects are described, and will become apparent to persons skilled in the art upon reading the following detailed description and viewing the drawings that form a part thereof.

An exemplary method implemented in a firmware domain and a hardware domain is disclosed. The method may comprise writing, by the firmware domain, configuration information to a memory for a plurality of passes of hardware processing. The method may also comprise programming, by the hardware domain, configuration registers with the configuration information retrieved from the memory. The method may further comprise processing, by the hardware domain, the plurality of passes in accordance with the configuration information programmed in the configuration registers. Programming the configuration registers may occur subsequent to the configuration information being written to the memory.

An exemplary apparatus is disclosed. The apparatus may comprise a firmware domain, a hardware domain, and a memory accessible by both the firmware and hardware domains. The firmware domain may comprise a firmware processor configured to write configuration information to the memory for a plurality of passes of hardware processing. The hardware domain may comprise a register reconfiguration using direct descriptor fetch (RRDF) controller and a hardware core. The RRDF controller may be configured to program configuration registers with the configuration information retrieved from the memory. The hardware core may be configured to process the plurality of passes in accordance with the configuration information programmed in the configuration registers. The RRDF controller may program the configuration registers subsequent to the firmware processor writing the configuration information to the memory.

Another exemplary apparatus is disclosed. The apparatus may comprise means for writing configuration information to a memory for a plurality of passes of hardware processing. The apparatus may also comprise means for programming configuration registers with the configuration information retrieved from the memory. The apparatus may further comprise means for processing the plurality of passes in accordance with the configuration information programmed in the configuration registers. The means for programming may program the configuration registers subsequent to the means for writing writes the configuration information to the memory.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of examples of one or more aspects of the disclosed subject matter and are provided solely for illustration of the examples and not limitation thereof:

FIG. 1 illustrates a conventional processing system with hardware (HW) software interface (SWI) registers programming by firmware (FW) processors;

FIG. 2 illustrates an example processing system with HW SWI registers programming by HW processors according to exemplary aspects of this disclosure;

FIG. 3 illustrates a comparison between the exemplary Register Reconfiguration using Direct Descriptor Fetch (RRDF) and conventional non-RRDF programming;

FIGS. 4A-B respectively illustrate a table with a sample programming sequence and a DDR descriptor prepared by FW for the table according to exemplary aspects of this disclosure;

FIG. 5 illustrates a multi-thread synchronization according to exemplary aspects of this disclosure;

FIG. 6 illustrates two HW thread example address descriptors with MARKERs according to exemplary aspects of this disclosure;

FIG. 7 illustrates another table with sample programming sequences for quantifying the number of cycles involved in non-RRDF programming according to exemplary aspects of this disclosure; and

FIG. 8 illustrates a flow chart of an example method for programming SWI registers and processing based on the programming according to exemplary aspects of this disclosure.

### DETAILED DESCRIPTION

Aspects of the subject matter are provided in the following description and related drawings directed to specific examples of the disclosed subject matter. Alternates may be devised without departing from the scope of the disclosed subject matter. Additionally, well-known elements will not be described in detail or will be omitted so as not to obscure the relevant details.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage, or mode of operation.

The terminology used herein describes particular aspects only and should not be construed to limit any aspects disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

Exemplary aspects of this disclosure are directed to decoupling programming of the SWI registers through FW and the HW processing, to minimize the FW interventions in the overall processing. In exemplary aspects, the FW is configured to prepare all the required programming sequences for the SWI registers in advance and to store the prepared programming sequences in external memory (e.g., DDR). The FW may then initiate the exemplary HW scheme referred to as Register Reconfiguration using Direct Descriptor Fetch (RRDF). RRDF is designed to fetch the programming sequence data from the external memory and configure the SWI registers using HW (e.g., a HW core may fetch the programming sequence from the external memory and configure the SWI registers in HW without requiring FW intervention). Accordingly, FW is enabled to independently compute all the required parameters and prepare the required buffers to store the programming sequences, while HW may read and program the registers at a significantly higher speed than is possible with the conventional FW programming of the SWI registers.

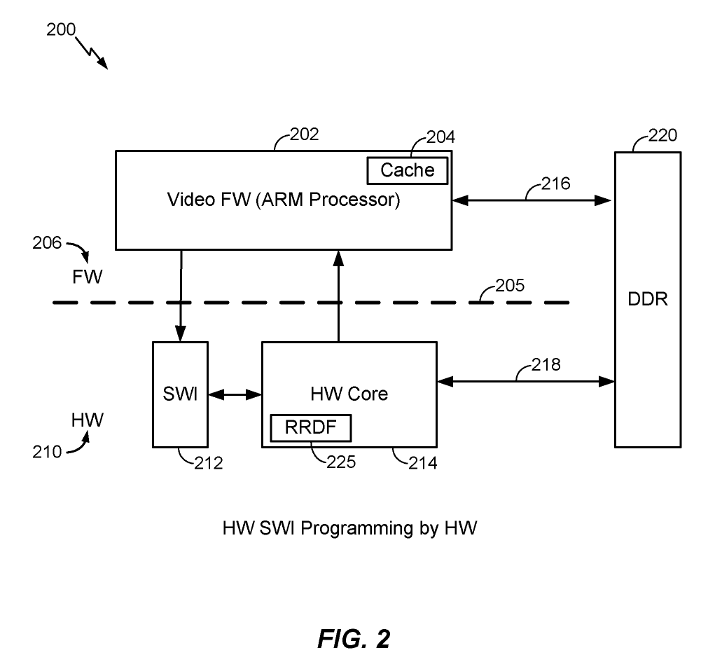

FIG. 2 illustrates an example processing system 200 showing a HW-FW partition 205 between the FW domain 206 and the HW domain 210. In more detail, the exemplary processing system 200 may include a processor 202 for video FW processing (e.g., an ARM processor) with a cache 204 in the FW domain 206, and SWI registers 212 and HW core 214 in the HW domain 210. The HW core 214 may include a RRDF controller 225. In an aspect, the HW core 214 may be implemented in an application specific integrated circuit (ASIC). Alternatively or in addition thereto, the RRDF controller 225 may be implemented in an ASIC. In yet another alternative, both the HW core 214 and the RRDF controller 225 may be integrated together in one ASIC.

The processing system 200 may also include memory 220 (e.g., DDR memory), with respective interfaces 216 and 218 to the FW domain 206 and the HW domain 210. The memory 220 may be external to both the FW and HW domains 206, 210. The RRDF controller 225 may be configured to fetch the programming sequence data from the memory 220 and configure the SWI registers 212.

The processing system 200 implementing the RRDF controller 225 can significantly reduce the latencies as compared to the conventional processing system 100. In the conventional processing system 100, the FW processor 102 programs the SWI register 112, the HW core 114 processes a thread in accordance with the programming and initiates the IRQ when the current interval ends, and the FW processor 102 programs the SWI register 112 for the next interval upon detection of the IRQ. This loop can take a considerable amount of time—i.e., can result in significant latencies. Also, the loop is repeated multiple times, meaning that the latencies can accumulate. Note that in the conventional processing system 100, the HW core 114 only reads from the SWI registers 112, as indicated by a single ended arrow from the SWI registers 112 to the HW core 114. The SWI registers 112 are programmed by the FW processor 102 in each loop.

However, in the proposed processing system 200, the FW domain 206 (e.g., the FW processor 202) may prepare and prepopulate the memory 220 with multiple programming sequences and simply initiate the HW domain 210 (e.g., the HW core 214) to proceed. The HW core 214, with the RRDF controller 225, may then retrieve the programming sequence from the memory 220 to program the SWI registers 212 and process the thread in accordance with the programming. When the current interval ends, instead of generating the IRQ and waiting for the FW processor 202, the HW domain 210 (e.g., HW core 214, RRDF controller 225) itself can retrieve the next programming sequence from the memory 220 to program the SWI registers 212 (which is unlike the conventional processing system 100) and process the thread accordingly. As a result, the latencies associated with programming the SWI registers 212 can be reduced significantly. Note that unlike the conventional processing system 100, the HW core 214 of the proposed processing system 200 may also write to, as well as read from, the SWI registers 212, as indicated by a double ended arrow between the SWI registers 212 and the HW core 214.

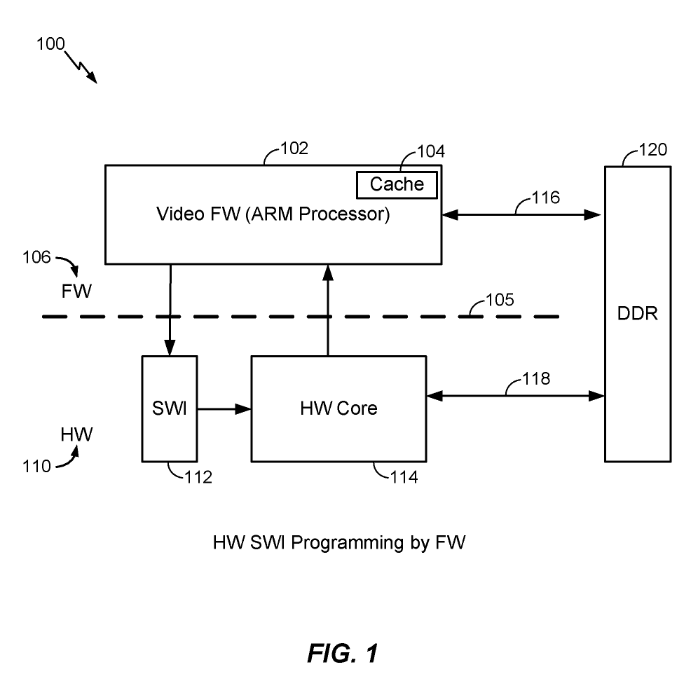

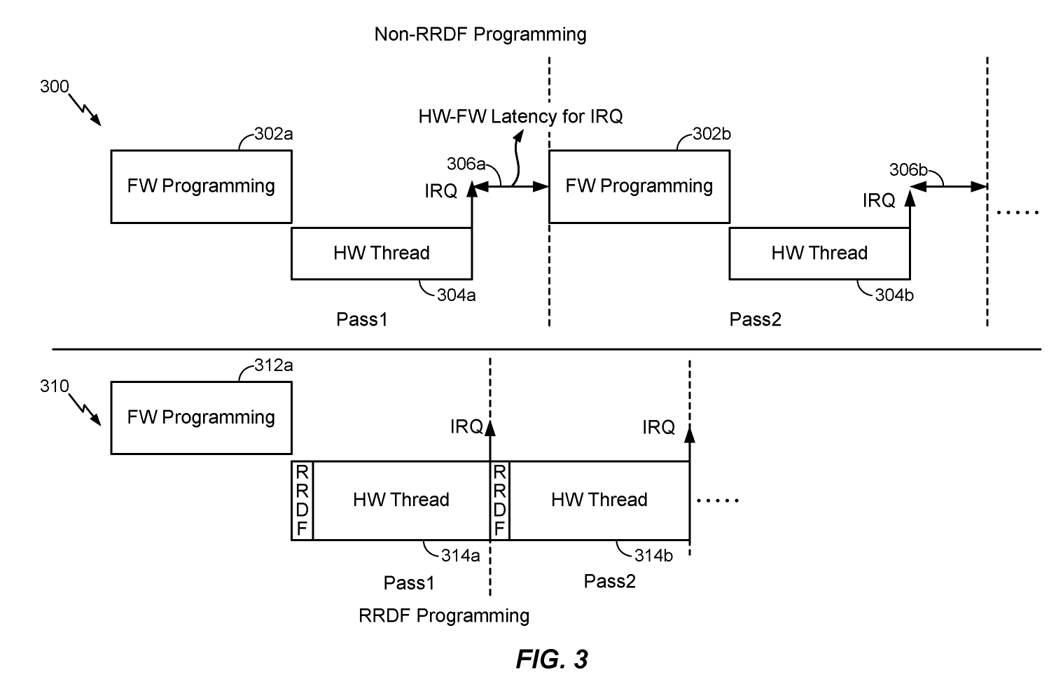

With reference to FIG. 3, a comparison of timelines associated with the conventional SWI programming (e.g., as per FIG. 1, and referred to herein as non-RRDF programming to distinguish from the exemplary RRDF programming) with exemplary RRDF programming (e.g., as per FIG. 2) is shown. In more detail, FIG. 3 shows that in the case of the conventional non-RRDF programming, denoted by the reference numeral 300, a respective FW programming event 302a-b is required prior to programming/execution of each one of HW threads 304a-b. Thus subsequent to completion of each of the HW threads 304a-b, there is a corresponding delay 306a-b associated with generating the respective IRQ by the HW threads 304a-b and processing the IRQ by FW and initiating the subsequent programming of the SWI registers before the next frame, or “pass” of HW execution can begin. Two passes, pass 1 and pass 2 are illustrated for corresponding HW threads 304a and 304b, which may represent two frames or any other periodic processing by hardware threads. It is also noted that FW may not know when each HW thread's execution will be complete, and so FW may need to monitor the IRQs for a continued period of time, which may also incur unnecessary resource expenditure.

On the other hand, for RRDF programming denoted by the reference numeral 310, a single FW programming event 312a is sufficient for the programming of both of the HW threads 314a-b in the example shown. Interrupt processing (IRQ) does not incur delays such as 306a-b shown in the non-RRDF conventional implementation. This is because the FW need not monitor the IRQ reception from the HW threads 314a-b for subsequent programming of the SWI registers. Rather, once the execution of HW thread 314a is completed, for example, based on an initial programming of the SWI registers during FW programming 312a (which can involve writing to external memory and reading from external memory to program the SWI registers through a HW core), the execution of the subsequent HW thread 314b may proceed entirely within HW by consulting the previously programmed SWI registers. Accordingly, FIG. 3 shows example savings (e.g., as illustrated by a much shorter timeline) for RRDF programming 310, which may be achieved by minimizing FW intervention between the HW pass 1 and pass 2.

To further explain the exemplary implementations, a general approach to reducing the cycles involved in block communication is considered. While an additional controller may be added among the various processing blocks of a processing sequence, in conventional implementations, a special interface or protocol may be required for interactions with the controller. On the other hand, in the exemplary implementations, the RRDF (e.g., RRDF controller 225) itself acts as the controller between the blocks (e.g., the HW threads) without the need for any special interfaces. In the RRDF, the existing interfaces may be reused, without requiring any changes to the blocks. Such RRDF implementations may be suitable in example implementations which utilize an SWI interface.

Once the FW derives the required programming sequence in exemplary aspects, the FW may prepare a buffer with the required programming sequence, wherein the programming sequence may comprise the SWI address and corresponding write data. The RRDF scheme enables the FW to prepare the programming sequences corresponding to independent HW threads (or passes) in advance.

In some aspects, the SWI address and data may be separated into two different buffers. Since the programming sequence may be substantially invariable or fixed for a particular use case, the data may vary while the addresses remain constant. Thus, by separating out the address and data buffers, the address buffer can be copied a single time and the data buffers, as they vary, can be modified in the SWI programming, without requiring multiple copies of the invariant address buffer. Thus, further efficiencies may be achieved in these aspects.

Accordingly, the FW may initially prepare the address buffer a single time, and while retaining the same address buffer, continue to update the configuration (data) values in the SWI registers for subsequent passes. This way, the FW may reduce the overhead involved in maintaining the buffers, rather than configuring both address and data every time.

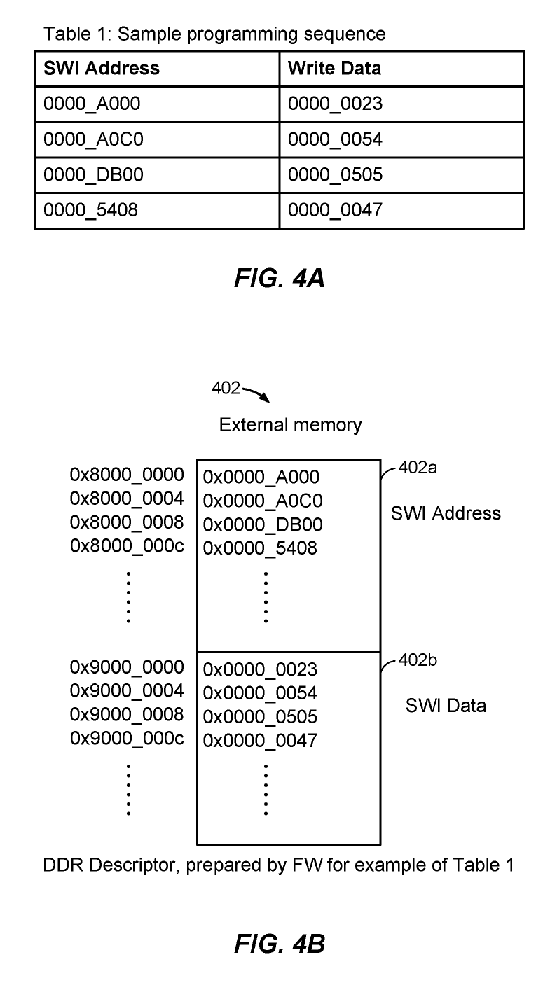

With reference now to FIG. 4A, an illustrative programming sequence is shown in Table 1, and FIG. 4B illustrates an example descriptor, @DDR, corresponding to Table 1 of FIG. 4A. With combined reference to FIGS. 4A-B, Table 1 of FIG. 4A shows SWI addresses which may be configured in an address buffer 402a of external memory 402 (e.g., memory 220), and an example set of corresponding configuration data which may be stored in the data buffer 402b also of the external memory 402 for an example pass. The FW (e.g., FW processor 202) may prepare and write the address buffer 402a with the addresses, including start address and size of the descriptor and initiate the RRDF processes by asserting an indication such as “START”. The RRDF scheme may then utilize a HW processor (e.g., HW core 214 with RRDF controller 225) to fetch the descriptor directly from the external memory 402, thus decoupling the HW processor and FW programming. The HW processor may program the corresponding registers SWI registers (e.g., SWI registers 212), following the same sequence (or order) of the contents of the address buffer 402a and the related data buffer 402b.

Accordingly, separating the SWI address and the data into two descriptors is seen to provide more generality and flexibility for the FW in the exemplary RRDF scheme. For example, with continued reference to FIGS. 4A-B, the FW may also program the size and valid bytes to RRDF, indicating the total number of registers to be programmed. The HW processor may then receive the start address of SWI address descriptor as 0x8000_0000 and that of SWI Data descriptor as 0x9000_0000. The RRDF scheme may enable the HW processor to continuously read data from the corresponding locations in data buffer 402b until the programmed size is reached. The HW processor may subsequently pair the SWI address and the corresponding SWI Data together to program the SWI registers.

In an aspect of multi-pass processing and multi-thread synchronization, in addition to the above-described programming of the SWI registers, the RRDF scheme also allows for synchronization between multiple threads. In an example process denoted as “SYNC_EVENT”, the FW can insert one or more predetermined addresses in the SWI address buffer 402a, referred to herein as a “MARKER”. Each MARKER may correspond to an interrupt from a particular thread. If a MARKER is encountered in an address buffer 402a, the RRDF scheme may halt further programming and wait for the completion of the corresponding EVENT. The advantages of this feature are illustrated in the following example scenarios: (1) there are multiple concurrent HW threads wherein execution of each thread may be dependent on the completion of other thread, and (2) multi-pass processing of a video frame in the same HW thread, wherein the SWI configuration of each pass is predetermined.

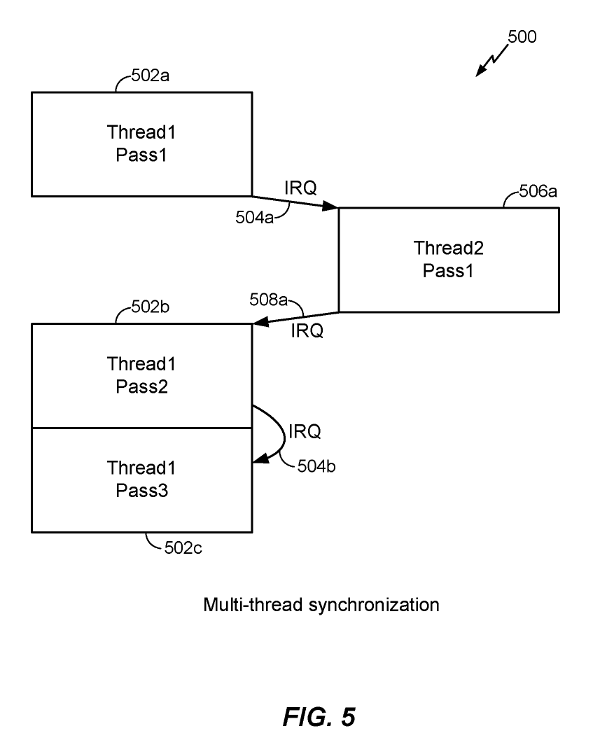

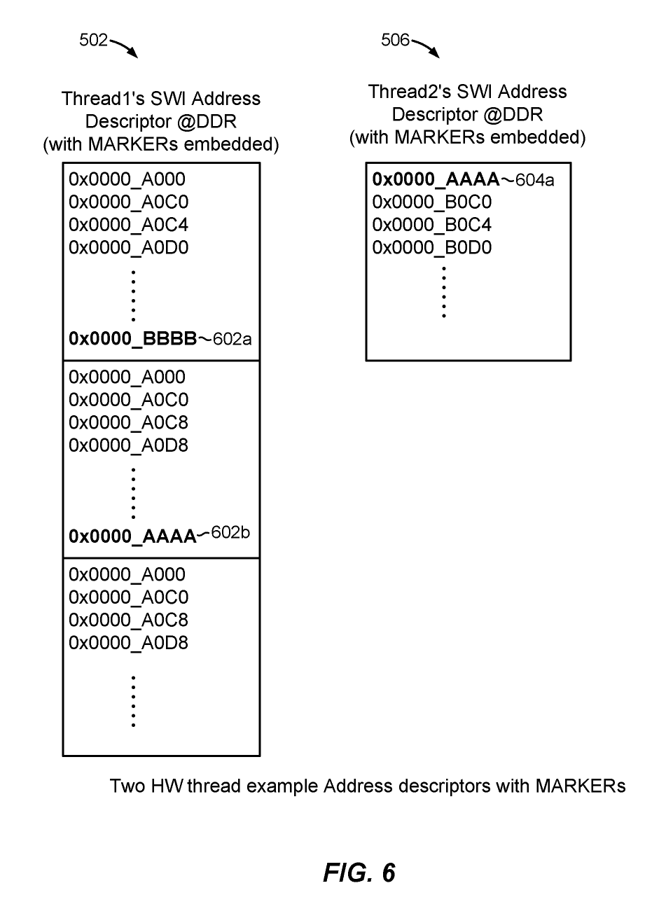

With combined reference to FIGS. 5-6, aspects of the above-mentioned thread synchronization are illustrated. As shown in FIG. 5, two concurrent HW threads, Thread1 and Thread2 may be running on a processor for a particular use case, wherein Thread1 may have a total of 3 passes (pass1-3 designated by reference numerals 502a-c) and Thread2 may have only 1 pass (pass 1 506a).

In an example with combined reference to FIGS. 5-6, Thread2's pass1 506a may start after completion of Thread1's pass1 502a. This may be achieved by the use of a MARKER shown as 604a in FIG. 6, in the address buffer of Thread2's pass 1 506a, to indicate that Thread2 is to wait for an interrupt, IRQ 504a from Thread1 before proceeding. Continuing with the example, Thread1's pass2 502b may have another MARKER shown as 602a in FIG. 6, to effectuate the start of Thread 1's pass2 502b after Thread2's pass 1 506a is complete, indicated by the receipt of IRQ 508a from Thread2. Similarly, Thread1's pass3 502c may have another MARKER shown as 602b in FIG. 6, to effectuate the start of Thread 1's pass3 502c after Thread1's pass2 502b is complete, indicated by the receipt of IRQ 504b from Thread1.

Referring to FIG. 6 in further detail, the address 0x0000_AAAA acts as the MARKER 604a for “Event of waiting for Thread1 IRQ” (504a from FIG. 5) and the address 0x0000_BBBB acts as the MARKER 602a for Thread2 IRQ (508a from FIG. 5). Each MARKER may be a predetermined address value, and there may be one or more MARKERs defined. While processing the address descriptor, if the exemplary RRDF scheme identifies these MARKERs, it enters into a wait state until the related IRQ is received from the thread. As can be seen from Thread2's address descriptor, where the first address itself is MARKER 604a (0x0000_AAAA), the RRDF waits for IRQ 504a from Thread1's Pass1 502a. Once Thread2 receives the IRQ 504a, the RRDF will continue programming for Thread2, with the starting address as 0x0000_B0C0. Similarly, Thread1 sees MARKER 602a (0x0000_BBBB) after Thread2's pass1 506a completion so Thread1 waits to receive IRQ 508a from Thread2 before programming 0x0000_A000.

Exemplary aspects of RRDF may be used in the implementation of video processing algorithms (e.g., CVP) like object detection and video processing like true motion estimation. The following is an non-exhaustive list of some example use cases that may benefit from the exemplary RRDF scheme: TME-Search. TME-HOG, CV-HOG-SVM, and High Frame Rate Vcodec processing

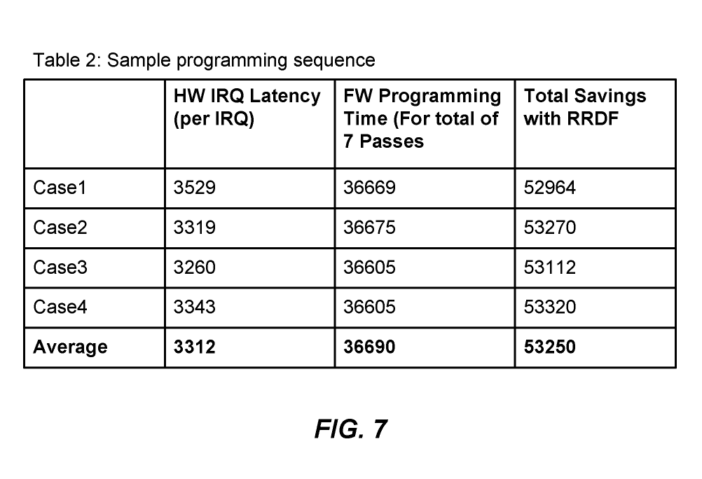

In FIG. 7, Table 2 quantifies the total cycles required if RRDF is not used in one of the VIDEO/CVP use cases. Table 2 shows results from four (4) use cases, wherein each case involves 7 HW passes. For these use cases, even with RRDF, the FW still waits on 2 IRQs for noticing the completion, so for total of 7 passes, 5 IRQ latencies may be saved.

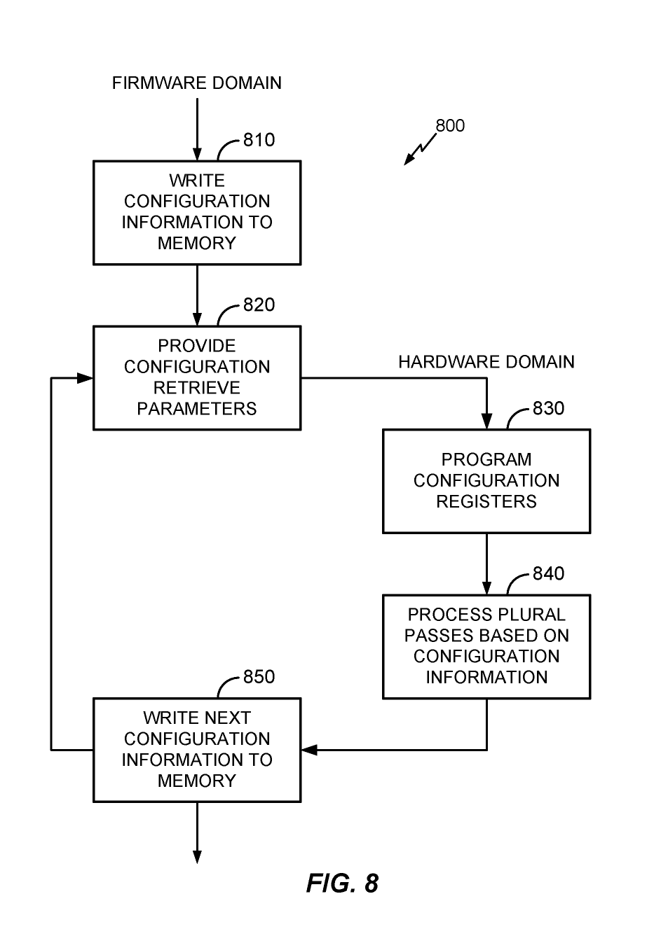

FIG. 8 illustrates a flow chart of an example method 800 implemented to program configuration registers and processing a plurality of passes in accordance with configuration information programmed in the configuration registers. The example method 800 may be implemented in firmware and hardware domains. To illustrate decoupling of the programming of the configuration registers and processing thereof, blocks associated with the firmware domain (blocks 810, 820, 850) are provided on the left and blocks associated with the hardware domain (blocks 830, 840) are provided on the right. The firmware domain (e.g., the firmware domain 206) may include a firmware processor (e.g., the firmware processor 202), and the hardware domain (e.g., the hardware domain 210) may include an RRDF controller (e.g., the RRDF controller 225) and a hardware core (e.g., HW core 214). Examples of configuration registers may include SWI registers (e.g., SWI registers 212) in the hardware domain 210.

In block 810 of FIG. 8, the firmware processor may write the configuration information to the memory for a plurality of passes of hardware processing. The plurality of passes may be passes of a single hardware thread. Alternatively or in addition thereto, the plurality of passes may be passes of a plurality of hardware threads in which each hardware thread may comprise one or more passes.

In block 820, the firmware processor may provide configuration retrieve parameters to the hardware domain, e.g., to the RRDF controller. Then in block 830, the RRDF controller may program the configuration registers with the configuration information retrieved from the memory. The configuration registers may be programmed based on the configuration retrieve parameters. In block 840, the hardware core may process the plurality of passes in accordance with the configuration information programmed in the configuration registers.

In an aspect, block 810 may precede block 830. That is, the firmware processor may write the configuration information to the memory for the plurality of passes of hardware processing, and then the RRDF controller may program the configuration registers with the configuration information retrieved from the memory.

As indicated above, the SWI registers, which may be in the hardware domain, may be examples of the configuration registers. Also, the memory may comprise an SWI address buffer (e.g., address buffer 402a) and an SWI data buffer (e.g., data buffer 402b). The configuration information may be viewed as comprising a plurality of SWI addresses and a plurality of SWI data corresponding to the plurality of SWI addresses.

In this instance, the firmware processor may implement block 810 by writing the plurality of SWI addresses into the SWI address buffer, and by writing the plurality of SWI data into the SWI data buffer. Also, the RRDF controller may implement block 830 by retrieving the plurality of SWI addresses from the SWI address buffer, retrieving the plurality of SWI data from the SWI data buffer, and pairing, by the hardware, each SWI address with its SWI data to program the SWI registers.

In an aspect, when the configuration registers comprise the SWI registers, then it may be said that the configuration retrieve parameters include SWI retrieve parameters. In this instance, the SWI retrieve parameters provided by the firmware processor in block 820 to the RRDF controller may include an SWI address buffer start and an SWI data buffer start. The SWI address buffer start may be a start address of the SWI address buffer, and the SWI data buffer start may be a start address of the SWI data buffer. The RRDF controller may implement block 830 by retrieving the plurality of SWI addresses starting from the SWI address buffer start, and retrieving the plurality of SWI data starting from the SWI data buffer start. Further, the hardware core may implement block 840 by processing the plurality of passes in accordance with the programmed SWI registers.

In an alternative aspect, the SWI retrieve parameters may also include a program size indicating a total number of SWI registers to be programmed. Then the RRDF controller may implement block 830 by retrieving the plurality of SWI addresses and the plurality of SWI data until the program size is reached.

Recall that in block 810, the firmware processor may write the configuration information to the memory for a plurality of passes. Nevertheless, in another aspect, the RRDF controller and the hardware core may implement blocks 830 and 840 one pass at a time. That is, the RRDF controller may program the SWI registers and the hardware core may process the plurality of passes in accordance with the programmed SWI registers such that one pass is programmed in the SWI registers and processed prior to a next pass being programmed in the SWI registers and processed.

In a further aspect, synchronization among the plurality of passes may be maintained by the firmware processor inserting one or more predetermined address values in the SWI address buffer referred to as MARKERs. For example, if first and second passes are passes of the plurality of passes and the second pass is dependent on the first pass, the firmware processor may write a MARKER in the SWI address buffer corresponding to a second pass. This may occur when the firmware processor is performing block 810.

When the RRDF controller retrieves the MARKER from the SWI address buffer during retrieving the SWI addresses of the second pass, e.g., when performing block 830, the RRDF controller may wait for an IRQ from the first pass, e.g., when the first pass is processed. Upon detecting the IRQ from the first pass, the RRDF controller may resume retrieving the plurality of SWI addresses and the plurality of SWI data of the second pass. The first and second passes may be passes of a same hardware thread or passes of different hardware threads.

The method 800 may end after block 840. Optionally, in block 850, the firmware processor may prepare and write the next configuration information into the memory. Recall from above that one reason for separating out the SWI address and data into different buffers is that the programming sequence may be substantially invariable or fixed for a particular use case, i.e., the data may vary while the addresses remain constant. Thus, the firmware processor may implement block 850 by writing the next plurality of SWI data into the SWI data buffer without writing any of the next plurality of SWI addresses into the SWI address buffer, e.g., when the SWI addresses do not change. If block 850 is performed, then the method may proceed back to block 820.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer-readable media embodying a method implemented in a firmware-hardware interface. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method implemented in a firmware domain and a hardware domain, the method comprising:
writing, by the firmware domain, configuration information to a memory for a plurality of passes of hardware processing;
programming, by the hardware domain, configuration registers with the configuration information retrieved from the memory; and
processing, by the hardware domain, the plurality of passes in accordance with the configuration information programmed in the configuration registers,
wherein programming the configuration registers occurs subsequent to the configuration information being written to the memory.

2. The method of claim 1, wherein the plurality of passes comprise one or both of:
a plurality of passes of a hardware thread, and
passes of a plurality of hardware threads, each hardware thread comprising one or more passes.

3. The method of claim 1,
wherein the configuration registers comprise software interface (SWI) registers in the hardware domain,
wherein the configuration information comprises a plurality of SWI addresses and corresponding plurality of SWI data,
wherein the memory comprises an SWI address buffer and an SWI data buffer, and
wherein writing the configuration information to the memory comprises:
writing, by the firmware domain, the plurality of SWI addresses into the SWI address buffer; and
writing, by the firmware domain, the plurality of SWI data into the SWI data buffer.

4. The method of claim 3,
wherein programming the configuration registers comprises:
retrieving, by the hardware domain, the plurality of SWI addresses from the SWI address buffer;
retrieving, by the hardware domain, the plurality of SWI data from the SWI data buffer; and
pairing, by the hardware, each SWI address with its SWI data to program the SWI registers, and
wherein processing the plurality of passes comprises processing, by the hardware, in accordance with the programmed SWI registers.

5. The method of claim 4, further comprising:
providing, by the hardware domain to the hardware domain, SWI retrieve parameters comprising an SWI address buffer start and an SWI data buffer start, the SWI address buffer start being a start address of the SWI address buffer, and the SWI data buffer start being a start address of the SWI data buffer, and
wherein the hardware domain retrieves the plurality of SWI addresses starting from the SWI address buffer start, and retrieves the plurality of SWI data starting from the SWI data buffer start.

6. The method of claim 5,
wherein the SWI retrieved parameters further comprise a program size, and
wherein the hardware domain retrieves the plurality of SWI addresses and the plurality of SWI data until the program size is reached.

7. The method of claim 4, wherein the hardware domain programs the SWI registers and processes the plurality of passes in accordance with the programmed SWI registers one pass at a time such that such that a pass is programmed in the SWI registers and processed prior to a next pass being programmed in the SWI registers and processed.

8. The method of claim 4,
wherein the firmware domain writes a MARKER in the SWI address buffer corresponding to a second pass when the second pass is dependent on a first pass, the MARKER being a predetermined address value, and
wherein when the hardware domain retrieves the MARKER from the SWI address buffer during retrieving the SWI addresses of the second pass, the hardware domain waits for an interrupt (IRQ) from the first pass, and resumes retrieving the plurality of SWI addresses and the plurality of SWI data of the second pass upon detecting the IRQ from the first pass.

9. The method of claim 3, further comprising:
writing, by the firmware domain, next configuration information to the memory for a next plurality of passes of hardware processing, the next configuration information comprising a next plurality of SWI addresses and a corresponding next plurality of SWI data, and
wherein writing the next configuration information to the memory comprises writing, by the firmware domain, the next plurality of SWI data into the SWI data buffer without writing any of the next plurality of SWI addresses into the SWI address buffer.

10. An apparatus, comprising:
a firmware domain;
a hardware domain; and
a memory accessible by both the firmware and hardware domains,
wherein the firmware domain comprises a firmware processor configured to write configuration information to the memory for a plurality of passes of hardware processing,
wherein the hardware domain comprises:
a register reconfiguration using direct descriptor fetch (RRDF) controller configured to program configuration registers with the configuration information retrieved from the memory; and
a hardware core configured to process the plurality of passes in accordance with the configuration information programmed in the configuration registers, and
wherein the RRDF controller programs the configuration registers subsequent to the firmware processor writing the configuration information to the memory.

11. The apparatus of claim 10, wherein the plurality of passes comprise one or both of:
a plurality of passes of a hardware thread, and
passes of a plurality of hardware threads, each hardware thread comprising one or more passes.

12. The apparatus of claim 10,
wherein the configuration registers comprise software interface (SWI) registers in the hardware domain,
wherein the configuration information comprises a plurality of SWI addresses and corresponding plurality of SWI data,
wherein the memory comprises an SWI address buffer and an SWI data buffer, and
wherein the firmware processor is configured to:
write the plurality of SWI addresses into the SWI address buffer; and
write the plurality of SWI data into the SWI data buffer.

13. The apparatus of claim 12,
wherein the RRDF controller is configured to:
retrieve the plurality of SWI addresses from the SWI address buffer;
retrieve the plurality of SWI data from the SWI data buffer; and
pair each SWI address with its SWI data to program the SWI registers, and
wherein the hardware core is configured to process the plurality of passes in accordance with the programmed SWI registers.

14. The apparatus of claim 13,
wherein the firmware processor is configured to provide to the hardware domain SWI retrieve parameters comprising an SWI address buffer start and an SWI data buffer start, the SWI address buffer start being a start address of the SWI address buffer, and the SWI data buffer start being a start address of the SWI data buffer, and
wherein the RRDF controller is configured to:
retrieve the plurality of SWI addresses starting from the SWI address buffer start, and
retrieve the plurality of SWI data starting from the SW data buffer start.

15. The apparatus of claim 14,
wherein the SWI retrieved parameters further comprise a program size, and
wherein the RRDF controller is configured to retrieve the plurality of SWI addresses and the plurality of SWI data until the program size is reached.

16. The apparatus of claim 13, wherein the RRDF controller is configured to program the SWI registers and the hardware core is configured to process the plurality of passes in accordance with the programmed SWI registers one pass at a time such that such that a pass is programmed in the SWI registers and processed prior to a next pass being programmed in the SWI registers and processed.

17. The apparatus of claim 13,
wherein the firmware processor is configured to write a MARKER in the SWI address buffer corresponding to a second pass when the second pass is dependent on a first pass, the MARKER being a predetermined address value, and
wherein when the RRDF controller retrieves the MARKER from the SWI address buffer during retrieving the SWI addresses of the second pass, the RRDF controller is configured to
wait for an interrupt (IRQ) from the first pass, and
resume retrieving the plurality of SWI addresses and the plurality of SWI data of the second pass upon detecting the IRQ from the first pass.

18. The apparatus of claim 12,
wherein the firmware processor is configured to write next configuration information to the memory for a next plurality of passes of hardware processing, the next configuration information comprising a next plurality of SWI addresses and a corresponding next plurality of SWI data, and
wherein the firmware processor is configured to write the next configuration information to the memory by writing the next plurality of SWI data into the SWI data buffer without writing any of the next plurality of SWI addresses into the SWI address buffer.

19. The apparatus of claim 12,
wherein the firmware processor is an ARM processor, or
wherein any one or more of the RRDF controller and the hardware core are implemented as an application specific integrated circuit (ASIC), or
both.

20. An apparatus, comprising:
means for writing configuration information to a memory for a plurality of passes of hardware processing;
means for programming configuration registers with the configuration information retrieved from the memory; and
means for processing the plurality of passes in accordance with the configuration information programmed in the configuration registers,
wherein the means for programming programs the configuration registers subsequent to the means for writing writes the configuration information to the memory.
